(19) United States
(12) Patent Application Publication
(10) Pub. No.: US 2005/0216254 A1
(43) Pub. Date: Sep. 29, 2005

(54) System-resource-based multi-modal input fusion

(76) Inventors: Anurag K. Gupta, Palatine, IL (US); Tasos Anastasakos, San Jose, CA (US)

Correspondence Address: MOTOROLA, INC., 1303 EAST ALGONQUIN ROAD, IL01/3RD, SCHAUMBURG, IL, 60196, US

(21) Appl. No.: 10/808,126

(22) Filed: Mar. 24, 2004

(51) Int. Cl. G06F 17/27; G10L 15/04; G06K 9/72; G09G 5/08

(52) U.S. Cl. 704/9; 704/251; 382/229; 345/157

(57) ABSTRACT

A multi-modal input fusion (MMIF) (200) is made scalable based on the resources available. When system resources are low, the MMIF module will limit the number of elements in each set of related interpretations. Additionally, the number of sets generated can be increased or reduced based on an amount of system resources available. In order to accommodate the scalable MMIF module, a resource profile (205) is provided to the MMIF describing the amount of resources (memory, processing power, etc.) available, and/or an amount of resources the MMIF module can utilize. Based on the amount of resources the MMIF module calculates threshold values that are used to adjust the number of sets produced and the number of elements included within each set.

### FIELD OF THE INVENTION

The present invention relates generally to multi-modal input fusion and in particular, to system-resource-based multi-modal input fusion.

### BACKGROUND OF THE INVENTION

Multimodal input fusion (MMIF) technology is generally used by a system to collect and fuse multiple user inputs into a single meaningful representation of a user's intent for further processing. Such a system using MMIF technology is shown in FIG. 1. As shown, system 100 comprises user interface 101 and MMIF module 104. User interface 101 comprises a plurality of modality recognizers 102-103 that receive and decipher a user's input. Typical modality recognizers 102-103 include speech recognizers, type-written recognizers, and hand-writing recognizers, but may comprise other forms of modality recognition circuitry. Each modality recognizer 102-103 is specifically designed to decipher an input from a particular input mode. For example, in a multi-modal input comprising both speech and keyboard entries, modality recognizer 102 may serve to decipher the keyboard entry, while modality recognizer 103 may serve to decipher the spoken input.

As discussed, all user inputs need to be combined together for the system to understand the user's input and to take action. A multimodal user interface has a well-defined turn-taking mechanism consisting of a system and a user turn. Based on dialogue management strategy they can be interrupted by either the system or the user, or initiated as required (mixed-initiative). Some input modalities (either due to recognition or interpretation difficulties) generate multiple ambiguous results when they decipher a user input. If MMIF module 104 receives one or more ambiguous interpretations from one or more input modalities, then it must generate all possible combinations of the inputs and then select appropriate interpretations. Because of this, before combining the interpretations, MMIF module 104 classifies the interpretations into sets of related interpretations and then produces a single joint interpretation (integration) for each set. If the number of ambiguous interpretations generated by input modalities increase, then the number of possible sets of related interpretations also increases.

The integration process is complex and requires sufficient amount of computational resources in order to perform the combination of interpretations. The amount of computational resources required increases with the number of ambiguous interpretations because of the need to combine all the ambiguous interpretations to generate all possible combinations, and then choose those joint interpretations which are most credible. Since the amount of computational resources available on some devices, such as mobile phones, is usually limited, and changes dynamically at runtime, a need exists for a system-resource-based MMIF module that accommodates for variations in computational resources available to the MMIF module.

### BRIEF DESCRIPTION OF THE DRAWINGS

FIG. 1 is a block diagram of a prior-art system using MMIF technology.

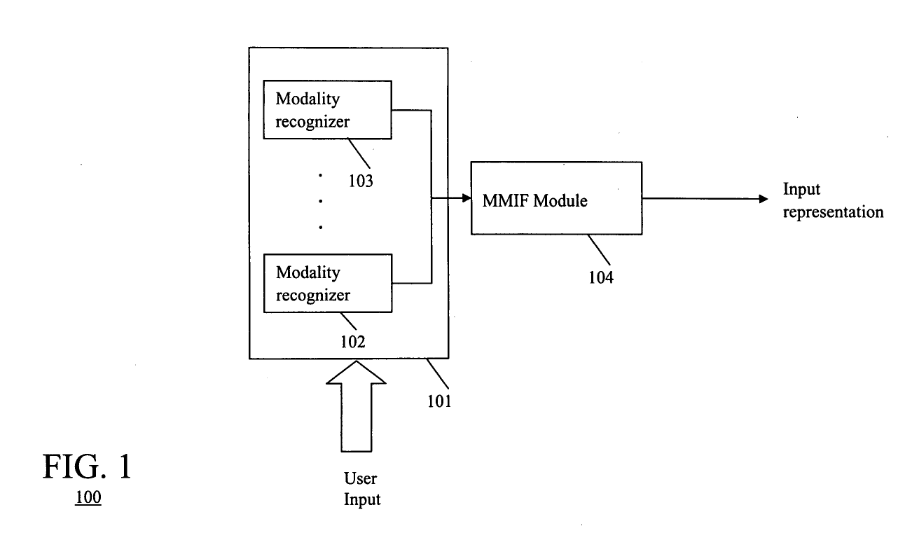

FIG. 2 is a block diagram of a system using MMIF technology.

FIG. 3 is a flow chart showing operation of the system of FIG. 1.

### DETAILED DESCRIPTION OF THE DRAWINGS

In order to address the above-mentioned need, a method and apparatus for system-resource-based MMIF is provided herein. In particular, the MMIF is made scalable based on the resources available. When system resources are low, the MMIF module will limit the number of elements in each set of related interpretations. Additionally, the number of sets generated can be increased or reduced based on an amount of system resources available. In order to accommodate the scalable MMIF module, a resource profile is provided to the MMIF describing the amount of resources (memory, processing power, etc.) available, and/or an amount of resources the MMIF module can utilize. Based on the amount of resources the MMIF module calculates threshold values that are used to adjust the number of sets produced and the number of elements included within each set.

The present invention encompasses a method for operating a system-resource-based multi-modal input fusion. The method comprises the steps of receiving a plurality of user inputs, determining an amount of system resources available, and creating sets of similar user inputs, wherein a number of similar user inputs within a set is based on the amount of system resources available.

The present invention additionally encompasses a method for operating a system-resource-based multi-modal input fusion. The method comprises the steps of receiving a plurality of user inputs, determining an amount of system resources available, and creating sets of similar user inputs, wherein a number of similar user inputs within a set is based on the amount of system resources available, and wherein a number of sets created is limited based on the amount of system resources available.

Finally, the present invention encompasses an apparatus comprising a plurality of modality recognizers receiving a plurality of user inputs, and a semantic classifier determining an amount of system resources available and creating sets of similar user inputs, wherein a number of user inputs within a set is based on the amount of system resources available.

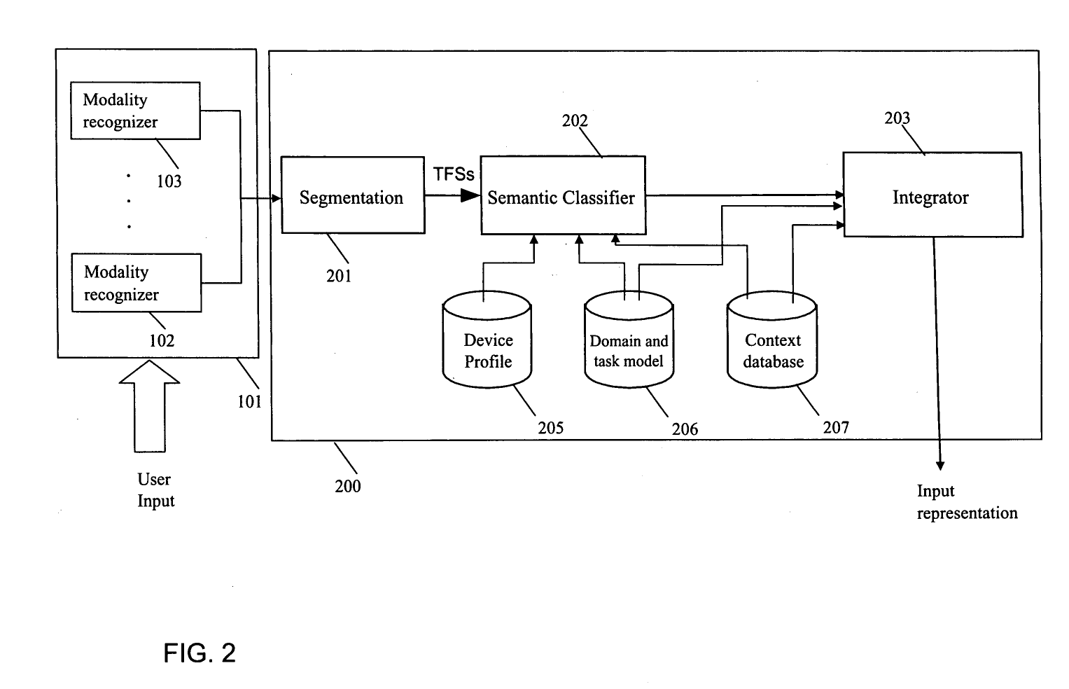

FIG. 2 shows MMIF 200. As is evident, MMIF 200 comprises segmentation circuitry 201, semantic classifier 202, and integrator 203. MMIF 200 also comprises several databases 205-207. In particular, device profile database 205 comprises a resource profile describing an amount of resources (memory, CPU, etc.) MMIF 200 can utilize. Domain and task model database 206 comprises a collection of all the concepts within an application and is a representation of the application's ontology. Finally, context database 207 comprises, for each user, a time sorted list of recent interpretations received by MMIF 200. It is contemplated that all elements within system 200 are configured in well-known manners with processors, memories, instruction sets, and the like, which function in any suitable manner to perform the function set forth herein.

During operation, a users input is received by interface 101. As is evident, system 200 comprises multiple input modalities where the user can use a single, all, or any combination of the available modalities (e.g., text, speech, handwriting, . . . etc.). Users are free to use the available modalities in any order and at any time. These inputs are received by recognizers 102-103 and recognizers output the received input to segmentation module 201. Segmentation module 201 serves to collect input interpretations from modality recognizers 102-103 until an end of the user turn, at which time, the collected interpretations are sent to semantic classifier 202 as Typed Feature Structures (TFSs).

A TFS is a collection of attribute value pairs and a confidence score. Each attribute can contain either a basic value of types integer, float, date, Boolean, string, etc. or a complex value as a nested typed feature structure. The type of a typed feature structure maps it to either a domain concept or a task. For example, an “Address” typed feature structure containing attributes “street number”, “street”, “city”, “state”, “zip” and “country” can be used to represent the concept of address of an object. An input modality can generate either an unambiguous interpretation (a single typed feature structure) or ambiguous interpretations (list of typed feature structures) for a user's input. Each interpretation is associated with a confidence score and optionally each attribute in the feature structure can have a confidence score.

Semantic classifier 202 serves as means for grouping the received inputs, (in this case received TFSs) into sets of related inputs and passing these sets to integrator 203 where joint interpretations for each set is obtained. Semantic classifier 202 additionally serves as means for limiting the number of TFSs each set contains as well as the amount of sets passed to integrator 203. Both the number of elements (TFSs) in each set, and the number of sets created are based on an amount of system resources available.

Limiting the Amount of Elements in Each Set

As discussed above, semantic classifier 202 collects all inputs from segmentation circuitry 201 and classifies the interpretations (TFSs) into sets of related interpretations. The sets of TFSs are passed to integrator 203 where integrator 203 produces a single joint interpretation (integration) for each set. Semantic classifier 202 receives each input (as a TFS for unambiguous input or a list of TFSs for ambiguous input) and calculates a “score” for the TFSs contained in an ambiguous input. A TFS is only included in a set when the score is above a threshold value. In the preferred embodiment of the present invention, the threshold value is allowed to vary based on system resources available. This works as follows:

The system resources available are accessed by semantic classifier 202 from device profile database 205. Once available resources are known, semantic classifier 202 then limits the number of TFSs classified within the sets. In particular, semantic classifier 202 accesses device profile database 205 to calculate a value of a threshold T. Semantic classifier 202 then calculates a content score of the TFS. The content score for each TFS is defined as a function of several variables such that:
ContentScore(TFS)=f(N, N_{A}, N_{R}, N_{M}, CS(i)|ᵢ₌₁^{N}).
where
N=number of attributes in TFS,
N_{A}=number of attributes in TFS having a value,
N_{R}=number of attributes in TFS with redundant values,
N_{M}=number of attributes in TFS with missing explicit reference, and
CS(i)=confidence score of the i^{th} attribute of TFS.

For each ambiguous input, semantic classifier 202 then includes only those TFSs that have a content score greater than the threshold T. If none of the TFS of an ambiguous input have an overall score greater than the threshold T, then the semantic classifier 202 selects only the TFS having the highest overall score amongst the TFSs in the ambiguous input. Semantic classifier 202 discards the TFSs that have not been selected and classifies the selected TFSs into sets of related interpretations.

In addition to limiting the number of TFSs within a set based on the content score, the number of TFSs within a set may also be limited based on how relevant the TFSs are to prior-received TFSs. In particular, semantic classifier 202 accesses context database 207 and retrieves typed feature structures received during previous turns. As discussed above, context database 207 stores, for each user, a time sorted list of recent interpretations received by the MMIF. Semantic classifier 202 utilizes this information to provide a function (contextScore(TFS)) to return a score (between 0 and 1) based on the match between a typed feature structure and typed feature structures received during previous turns. The contextScore(TFS) for a particular TFS is defined as a function h(Dₘ, RS(TFS,TFSₘ)). In particular,
contextScore(TFS)=RS(TFS,TFSₘ)/Dₘ,
where
Dₘ=number of turns elapsed since TFSₘ was received,
RS=Relationship Score (see below),
TFSₘ=a TFS received m turns ago.

Only those TFSs having a context score above a context threshold will be included within the set. In order to limit the amount of TFSs included within each set, the context threshold will be allowed to vary based on system resources. In particular, when system resources are limited, the context threshold will be decreased. Thus, by limiting the number of TFSs that are included in each set based on system resources available, the number of TFSs in each set increases when more system resources are available, and decreases as system resources become limited.

It should be noted that although the above description was given with respect to limiting the amount of TFSs included in each set based on a content score or a context score, one of ordinary skill in the art will recognize that the amount of TFSs in each set may be limited based on both the content score and the context score.

Limiting the Amount of Sets Created

As discussed above, semantic classifier 202 collects all inputs from segmentation circuitry 201 and classifies the interpretations into sets of related interpretations. The sets of related interpretations are passed to integrator 203 where a single joint interpretation (integration) for each set is created. As the number of sets passed to integrator 203 increases, so does the computational complexity of integrating the user's input. Thus, by limiting the number of sets passed to integrator 203, lower computational complexity can be achieved when integrating the elements of each set into a single joint interpretation.

In order to limit the amount of sets created, semantic classifier 202 accesses device profile 205 to calculate the value of a “content threshold” CT. Then a relationship score (RS) between each TFS is calculated such that the score between two TFSs is a function of the TFSs such that
RS(TFS₁,TFS₂)=m(Rel(TFS₁,TFS₂)),
where
Rel is a function that maps the relationship between TFS₁ and TFS₂ as defined in the Domain and Task Model database 206 to a symbol.

Then Semantic Classifier 202 calculates a “set content score” for each set. The “set content score” of a set is a function of the Relationship Score (RS), the number of TFSs in the set, and the confidence score of the TFSs contained in the set such that
SetContentScore=k(N,RS(TFSᵢ,TFSⱼ)|_{i=1,j=1,i≠j}^{N},ConfidenceScore(TFSᵢ)|ᵢ₌₁^{N}),
where,
N=number of TFSs in the set,
TFSᵢ=i^{th} TFS in the set,
ConfidenceScore=confidence score of a TFS,
RS=Relationship score.

Semantic classifier 202 then selects only those sets that have a “set content score” greater than CT. If none of the sets have a “set content score” greater than CT, then semantic classifier 202 selects only the set having the highest score amongst the sets created. Semantic Classifier 202 discards the sets that have not been selected and passes the selected sets to integrator 203. Once the selected sets are passed to integrator 203, integrator 203 produces a single joint interpretation (integration) for each set. This is accomplished as known in the art via standard joint-interpretation techniques. Once a joint interpretation for each set is achieved, a representation of the user's input is then output.

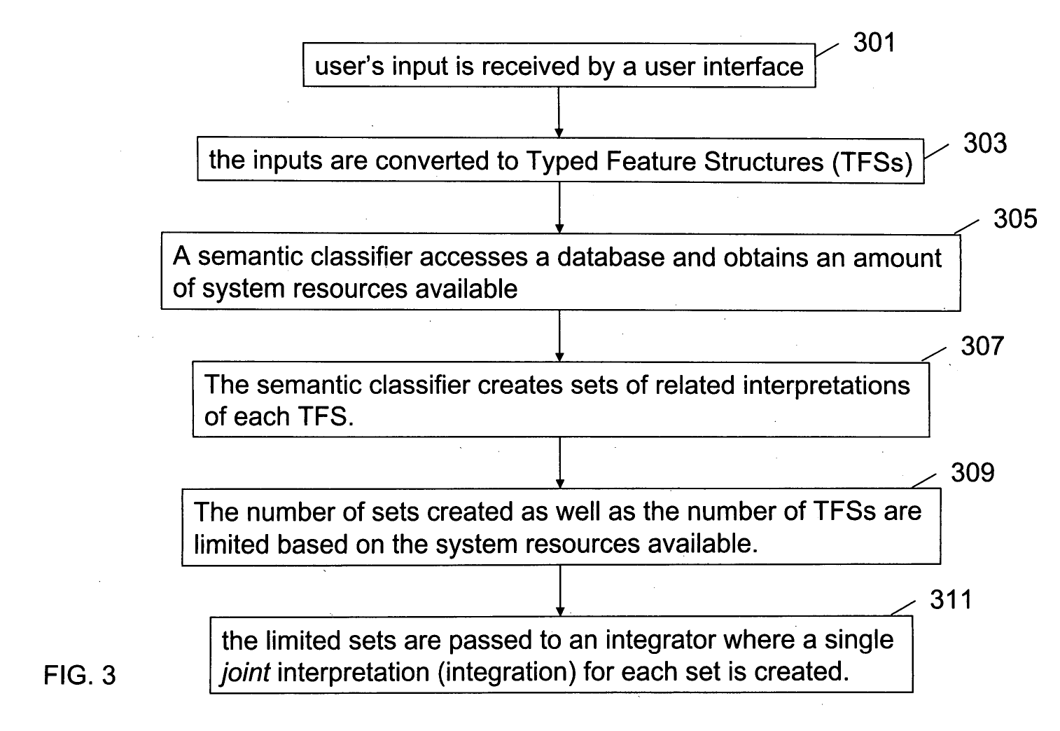

FIG. 3 is a flow chart showing operation of MMIF 200. The logic flow begins at step 301 where the user's input is received by interface 101. At step 303 the inputs are converted to Typed Feature Structures (TFSs) and output to semantic classifier 202. Semantic classifier accesses device profile database 205 and obtains an amount of system resources available (step 305), and at step 307 semantic classifier 202 creates sets of related interpretations of each TFS. It should be noted that while in the preferred embodiment of the present invention semantic classifier 202 received TFSs as user inputs, in alternate embodiments of the present invention, semantic classifier 202 may receive other types of user inputs. For example, semantic classifier 202 may simply receive the user input output from interface 101 and create sets of related interpretation for each input received from interface 101.

Continuing, at step 309 the number of sets created as well as the number of TFSs are limited based on the system resources available. As discussed above, the number of TFSs per set may be limited based on the content score, context score, or a combination of both. Additionally, the number of sets created may be limited based on “set content score”. Finally, at step 311 the limited sets are passed to integrator 203 where a singlejoint interpretation (integration) for each set is created.

As discussed above, as the number of sets passed to integrator 203 increases and as the number of TFSs in each set increases, so does the computational complexity of integrating the user's input. Thus, by limiting the number of sets passed to the integrator, and by limiting the number of TFSs in each set, lower computational complexity can be achieved when integrating the elements into a single joint interpretation.

While the invention has been particularly shown and described with reference to a particular embodiment, it will be understood by those skilled in the art that various changes in form and details may be made therein without departing from the spirit and scope of the invention. For example, although the above description limited computational complexity by both limiting the number of sets created, and limiting the number of elements in each set, one of ordinary skill in the art will recognize that in alternate embodiments of the present invention computational complexity may be limited by performing either task alone. It is intended that such changes come within the scope of the following claims.

1. A method for operating a system-resource-based multi-modal input fusion, the method comprising the steps of:
receiving a plurality of user inputs;
determining an amount of system resources available; and
creating sets of similar user inputs, wherein a number of similar user inputs within a set is based on the amount of system resources available.

2. The method of claim 1 further comprising the steps of:
converting the plurality of user inputs into Typed Feature Structures (TFSs); and
wherein the step of creating sets of similar user inputs comprises the step of creating sets of similar TFSs, wherein the number of TFSs within a set is based on the amount of system resources available.

3. The method of claim 2 wherein the step of converting the plurality of user inputs into Typed Feature Structures comprises the step of converting the plurality of user inputs into a plurality of attribute value pairs and confidence scores.

4. The method of claim 2 wherein the step of creating sets of similar TFSs comprises the step of creating sets of similar TFSs, wherein a TFS is included in a set if it has a content score greater than a threshold, wherein
ContentScore(TFS)=f(N, N_{A}, N_{R}, N_{M}, CS(i)|ᵢ₌₁^{N}),
where
N=number of attributes in TFS,
N_{A}=number of attributes in TFS having a value,
N_{R}=number of attributes in TFS with redundant values,
N_{M}=number of attributes in TFS with missing explicit reference, and
CS(i)=confidence score of the i^{th} attribute of TFS.

5. The method of claim 2 wherein the step of creating sets of similar TFSs comprises the step of creating sets of similar TFSs, wherein a TFS is included in a set if it has a context score greater than a threshold.

6. The method of claim 5 wherein the step of creating sets of similar TFSs comprises the step of creating sets of similar TFSs, wherein a TFS is included in a set if it has a context score greater than a threshold wherein
ContextScore(TFS)=h(Dₘ, RS(TFS,TFSₘ))
where
Dₘ=number of turns elapsed since receiving TFSₘ from a modality
RS=Relationship Score between TFS (current input) and TFSₘ
TFSₘ=a TFS received Dₘ turns ago.

7. The method of claim 1 wherein a number of sets created is based on the amount of system resources available.

8. The method of claim 1 wherein the step of receiving the plurality of user inputs comprises the step of receiving a plurality of multi-modal user inputs.

9. The method of claim 1 wherein the step of determining the amount of system resources available comprises the step of determining an amount of memory or processing power available.

10. The method of claim 1 wherein the step of creating sets of similar user inputs comprises the step of creating sets of similar user inputs, wherein a user input is included in a set if it has a content score greater than a threshold.

11. A method for operating a system-resource-based multi-modal input fusion, the method comprising the steps of:
receiving a plurality of user inputs;
determining an amount of system resources available; and
creating sets of similar user inputs, wherein a number of similar user inputs within a set is based on the amount of system resources available, and wherein a number of sets created is limited based on the amount of system resources available.

12. The method of claim 11 further comprising the steps of:
converting the plurality of user inputs into Typed Feature Structures (TFSs); and
wherein the step of creating sets of similar user inputs comprises the step of creating sets of similar TFSs, wherein the number of TFSs within a set is based on the amount of system resources available.

13. The method of claim 12 wherein the step of converting the plurality of user inputs into Typed Feature Structures comprises the step of converting the plurality of user inputs into a plurality of attribute value pairs and confidence scores.

14. The method of claim 11 wherein the step of receiving the plurality of user inputs comprises the step of receiving a plurality of multi-modal user inputs.

15. The method of claim 11 wherein the step of determining the amount of system resources available comprises the step of determining an amount of memory or processing power available.

16. An apparatus comprising:
a plurality of modality recognizers receiving a plurality of user inputs; and
a semantic classifier determining an amount of system resources available and creating sets of similar user inputs, wherein a number of user inputs within a set is based on the amount of system resources available.

17. The apparatus of claim 16 further comprising:
segmentation circuitry converting the plurality of user inputs into a plurality of Typed Feature Structures (TFSs); and
wherein the semantic classifier creates sets of similar TFSs, wherein the number of TFSs within a set is based on the amount of system resources available.

18. The apparatus of claim 17 wherein the number of sets created is limited based on the amount of system resources available.

19. The apparatus of claim 16 wherein the number of sets created is limited based on the amount of system resources available.
